(19) United States
(12) Patent Application Publication
(10) Pub. No.: US 2015/0131424 A1
(43) Pub. Date: May 14, 2015

(54) OPTICAL INFORMATION RECORDING/REPRODUCTION DEVICE, RECORDING CONDITION ADJUSTMENT METHOD, AND OPTICAL INFORMATION RECORDING MEDIUM

(71) Applicant: HITACHI CONSUMER ELECTRONICS CO., LTD., Yokohama, Kanagawa (JP)

(72) Inventors: Makoto Hosaka, Tokyo (JP); Kazuyoshi Yamazaki, Tokyo (JP)

(73) Assignee: Hitachi Consumer Electronics Co., Ltd., Yokohama, Kanagawa (JP)

(21) Appl. No.: 14/400,669

(22) PCT Filed: May 23, 2012
(86) PCT No.: PCT/JP2012/003352

§ 371 Date: Nov. 12, 2014

(51) Int. Cl. G11B 7/0065

(52) U.S. Cl. CPC G11B 7/0065
USPC 369/103

(57) ABSTRACT

An optical information recording/reproduction device appropriately adjusting a recording condition and a method and a medium therefor are provided in order to cope with a problem that the signal-to-noise ratio (SNR) during reproduction decreases, unless the condition during recording is adjusted, because of variation in the environment during recording, variation of components such as laser output, variation of production of the device, and the like in the optical information recording/reproduction device using holography. In an optical information recording/reproduction device configured to record or reproduce information to an optical information recording medium by using holography, a recording condition is adjusted, before user data are recorded, in an adjustment area provided for recording condition adjustment in an optical information recording medium.

### TECHNICAL FIELD

The present invention relates to a device, a method, and a medium for recording and/or reproducing information using holography.

### BACKGROUND ART

Currently, an optical disk having a recording density of about 100 GB even for consumer use can be produced commercially on the basis of Blu-ray Disc™ specification using blue-violet semiconductor laser. In the future, an optical disk is also desired to attain a high capacity of more than 500 GB. However, in order to achieve such extremely high density with an optical disk, it is required to have a high density technique according a new method different from a conventional high density technique which is a shorter wave length and a higher NA of a an object lens.

While next generation storage technique is researched, hologram recording technique for recording digital information using holography attracts attention. An example of hologram recording technique includes Japanese Patent Application 2004-272268 (PTL 1). This publication describes a so-called angle multiplexed recording method for performing multiplexed recording by displaying multiple page data on a spatial light modulation device while changing the incidence angle of the reference light into an optical information recording medium. Further this publication describes a technique for reducing the interval of adjacent holograms by condensing a signal light with a lens and arranging a diaphragm (spatial filter) at a beam waist thereof.

An example of hologram recording technique includes International Publication No. WO2004-102542 (PTL 2). This publication describes an example using a shift multiplexed method for recording a hologram by adopting a light from inner pixels as a signal light and a light from outer circular belt-like pixels as a reference light in a single spatial light modulation device, condensing both of the light beams onto an optical information recording medium using the same lens, and causing the signal light and the reference light to be interfered with each other at a position close to the focal plane of the lens.

An example of an adjustment technique of a recording condition during hologram recording includes Japanese Patent Application Laid-Open No. 2005-50522 (PTL 3). This publication recites in order to form a recording pattern of a desired diffraction efficiency using DRAW function, a test area is provided on the optical information recording medium 1 as necessary.”

### CITATION LIST

### Patent Literature

PTL 1: Japanese Patent Application Laid-Open No. 2004-272268

PTL 2: International Publication No. WO2004-102542

PTL 3: Japanese Patent Application Laid-Open No. 2005-50522

### SUMMARY OF INVENTION

### Technical Problem

By the way, an optical information recording/reproduction device using holography has a problem in that the signal-to-noise ratio (SNR) during reproduction decreases, unless the condition during recording is adjusted, because of variation in the environment during recording, variation of components such as laser output, variation of production of the device, and the like.

However, PTL 3 does not disclose any specific standard during adjustment of the recording condition.

The present invention is made in view of the above problems, and it is an object of the present invention to provide an optical information recording/reproduction device capable of recording a high quality hologram by appropriately adjusting a recording condition before recording, and to provide a method, and a medium therefor.

### Solution to Problem

The above problem is solved by the invention described in claims, for example.

### Advantageous Effects of Invention

According to the present invention, for example, an optical information recording/reproduction device capable of recording a high quality hologram in a holographic memory can be provided, and a method and a medium therefor can be provided.

### BRIEF DESCRIPTION OF DRAWINGS

FIG. 1 is a schematic diagram illustrating an embodiment of a recording condition adjustment circuit in an optical information recording/reproduction device.

FIG. 2 is a schematic diagram illustrating an embodiment of an optical information recording/reproduction device.

FIG. 3 is a schematic diagram illustrating an embodiment of a pickup in the optical information recording/reproduction device.

FIG. 4 is a schematic diagram illustrating an embodiment of the pickup in the optical information recording/reproduction device.

FIG. 5 is a schematic diagram illustrating an embodiment of the pickup in the optical information recording/reproduction device.

FIGS. 6(a) to 6(c) are schematic diagrams illustrating an embodiment of an operation flow of the optical information recording/reproduction device.

FIG. 7 is a schematic diagram illustrating an embodiment of a signal generation circuit in the optical information recording/reproduction device.

FIG. 8 is a schematic diagram illustrating an embodiment of the signal generation circuit in the optical information recording/reproduction device.

FIGS. 9(a) and 9(b) are schematic diagrams illustrating an embodiment of an operation flow of the signal generation circuit and signal processing circuit.

FIGS. 10(1) and 10(2) are schematic diagrams illustrating an embodiment of a layer structure of an optical information recording medium having a reflection layer.

FIGS. 11(a) and 11(b) are schematic diagrams illustrating an example of relationship of a reproduction light intensity and a reference light angle in an optical information recording/reproduction device.

FIG. 12 is a schematic diagram illustrating an example of relationship of an accumulative intensity and an accumulative exposure light energy density in the optical information recording/reproduction device.

FIG. 13 is a schematic diagram illustrating an embodiment of an optical information recording medium.

FIG. 14 is a schematic diagram illustrating an embodiment of an operation flow of recording condition adjustment in the optical information recording/reproduction device.

FIG. 15 is a schematic diagram illustrating an embodiment of a recording condition adjustment circuit in the optical information recording/reproduction device.

FIG. 16 is a schematic diagram illustrating an embodiment of an operation flow of recording condition adjustment in the optical information recording/reproduction device.

FIG. 17 is a schematic diagram illustrating an example of relationship of an SSR and a recording exposure light energy density in the optical information recording/reproduction device.

FIG. 18 is a schematic diagram illustrating an embodiment of a recording condition adjustment circuit in the optical information recording/reproduction device.

FIG. 19 is a schematic diagram illustrating an embodiment of an operation flow of recording condition adjustment in the optical information recording/reproduction device.

FIG. 20 is a schematic diagram illustrating an example of relationship of a recording exposure light energy density and a reference light angle in the optical information recording/reproduction device.

FIG. 21 is a schematic diagram illustrating an embodiment of an overall flow of recording condition adjustment in the optical information recording/reproduction device.

FIG. 22 is an example of information about pre-adjustment recording condition stored in advance in an optical information recording/reproduction device, a device for controlling an optical information recording/reproduction device, or an optical information recording medium, or a cartridge storing an optical information recording medium.

FIG. 23 is an example of a table of an exposure light energy density determined from M/# and sensitivity in the optical information recording/reproduction device.

FIG. 24 is an example of a table of a recording reference light angle and an exposure light time for each page in the optical information recording/reproduction device.

FIG. 25 is a schematic diagram illustrating an example of relationship of a recording exposure light energy density and a reference light angle in the optical information recording/reproduction device.

FIG. 26 is a schematic diagram illustrating an example of relationship of an SSR average value and a correction coefficient a in the optical information recording/reproduction device.

### DESCRIPTION OF EMBODIMENTS

Hereinafter, embodiments of the present invention will be explained with reference to drawings.

### First Embodiment

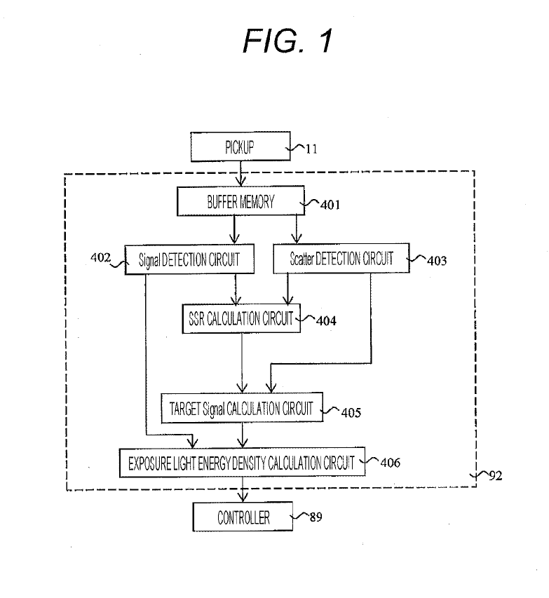

A first embodiment according to the present invention will be explained with reference to FIGS. 1 to 14, FIG. 20, and FIG. 21.

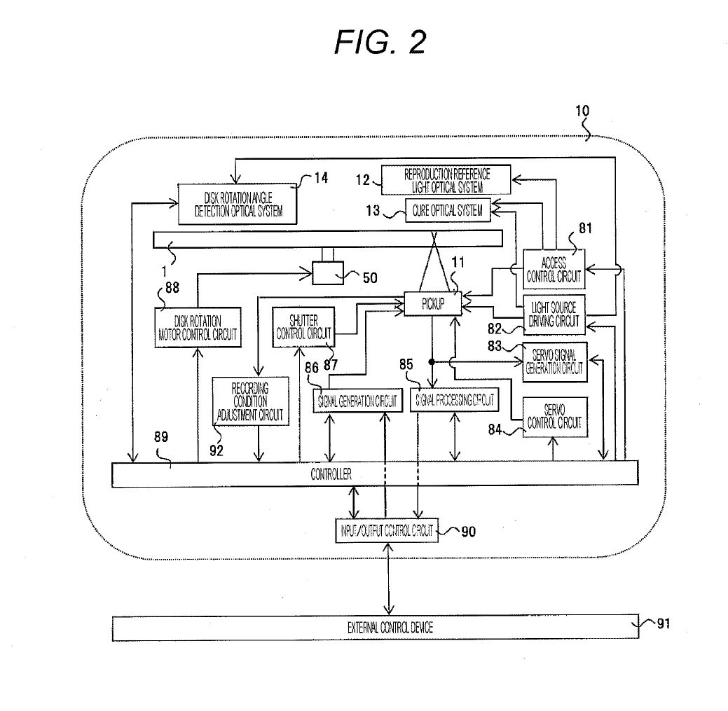

FIG. 2 is a block diagram illustrating a recording/reproduction device for an optical information recording medium which records and/or reproduces digital information by using holography.

An optical information recording/reproduction device 10 is connected via an input/output control circuit 90 to an external control device 91. When the optical information recording/reproduction device 10 performs recording, the optical information recording/reproduction device 10 causes the input/output control circuit 90 to receive an information signal, which is to be recorded, from an external control device 91. When the optical information recording/reproduction device 10 performs reproduction, the optical information recording/reproduction device 10 causes the input/output control circuit 90 to transmit the reproduced information signal to the external control device 91.

The optical information recording/reproduction device 10 includes a pickup 11, a reproduction reference light optical system 12, a cure optical system 13, a disk rotation angle detection optical system 14, and a rotation motor 50. An optical information recording medium 1 is configured to be rotatable with the rotation motor 50.

The pickup 11 is configured to emit a reference light and a signal light to the optical information recording medium 1, and records digital information to a recording medium by using holography. At this occasion, the information signal to be recorded is sent by a controller 89 via a signal generation circuit 86 into a spatial light modulation device provided in the pickup 11, so that the signal light is modulated by the spatial light modulation device.

When information recorded on the optical information recording medium 1 is reproduced, light wave for causing the reference light emitted from the pickup 11 to be incident upon the optical information recording medium in the direction opposite to recording is generated by the reproduction reference light optical system 12. The reproducing light reproduced by the reproduction reference light is detected by a light detection device explained later provided in the pickup 11, and the signal is reproduced by a signal processing circuit 85.

The recording condition adjustment circuit 92 inputs the information of the reproduction signal from the pickup 11, calculates the optimum exposure light energy density during recording, and outputs the optimum exposure light energy density to the controller 89. For example, the adjustment of the recording condition is performed in a predetermined area provided for recording condition adjustment on the disk, and in this specification, the disk area for the recording condition adjustment will be referred to as an adjustment area. This adjustment is processing similar to OPC (Optical Power Control) performed with a conventional bit-by-bit recording optical disk, and for example, the laser power density and the exposure light time during recording are adjusted. In the adjustment of the exposure light energy density, the adjustment may be performed by changing only the laser power density, or may be performed by changing only the exposure light time, or may be performed by changing both of the laser power density and the exposure light time. However, in order to stabilize the output and the coherence of the laser, a method for performing adjustment by changing the exposure light time may be desired. Information about pre-adjustment recording condition may be, for example, saved in advance in an optical information recording/reproduction device, a device for controlling an optical information recording/reproduction device, or an optical information recording medium, or a cartridge storing an optical information recording medium. In this case, the information about pre-adjustment recording condition may be, for example, information such as a recommended wavelength and an exposure light energy density of a pre-cure light source explained later as shown in FIG. 22, a reference light angle during page recording, a recommended laser wavelength and an exposure light energy density during page recording, a dark reaction time and a time for waiting dark reaction, a recommended wavelength and an exposure light energy density of a post-cure light source, the number of multiplex, a reference light angle during recording/reproduction, a recommended operation temperature, and a recommended operation humidity, and for example, the information may be saved in a table as information for each transfer speed and recording capacity. In addition, reproduction condition such as a recommended laser wavelength and an exposure light energy density during reproduction, a vale of a shrinkage factor caused by recording and post-cure, and a recommended wavelength change for ensuring the shrinkage factor may be stored in advance in an optical information recording/reproduction device, a device for controlling an optical information recording/reproduction device, or an optical information recording medium, or a cartridge storing an optical information recording medium. For example, the table may include multiple recording/reproduction conditions when the environment and the setting are changed, and may include, as information about an optical information recording medium, M/# and the sensitivity, a recommended SSR and a recommended SNR of page data recorded and reproduced. It should be noted that the table may not necessarily include all the information as shown in FIG. 22, and only necessary information may be saved.

The emission times of the reference light and the signal light emitted to the optical information recording medium 1 can be adjusted by controlling the open/close time of the shutter in the pickup 11 via a shutter control circuit 87 with the controller 89.

The cure optical system 13 is configured to generate the light beam used for pre-cure and post-cure of the optical information recording medium 1. The pre-cure is preprocessing for emitting a predetermined light beam in advance before the reference light and the signal light are emitted to a desired position when information is recorded to the desired position in the optical information recording medium 1. The post-cure is post-processing for emitting a predetermined light beam to the desired position so as to disable appending after the information is recorded to the desired position in the optical information recording medium 1.

The disk rotation angle detection optical system 14 is used to detect the rotation angle of the optical information recording medium 1. In a case where the optical information recording medium 1 is adjusted in a predetermined rotation angle, the disk rotation angle detection optical system 14 detects a signal according to a rotation angle, so that the rotation angle of the optical information recording medium 1 can be controlled using the detected signal via a disk rotation motor control circuit 88 with the controller 89.

A predetermined light source driving electric current from a light source driving circuit 82 is provided to light sources in the pickup 11, the cure optical system 13, and the disk rotation angle detection optical system 14, and each light source can emit light beam with a predetermined light quantity.

The pickup 11 and the disk cure optical system 13 are provided with mechanisms capable of sliding the position in the radius direction of the optical information recording medium 1, and the position control is performed via an access control circuit 81.

By the way, in the recording technique using the principle of angle multiplex of the holography, the allowable error tends to be extremely small with respect to deviation of the reference light angle.

Therefore, it is necessary to provide a mechanism in the pickup 11 for detecting the deviation quantity of the reference light angle, and to provide a servo mechanism in the optical information recording/reproduction device 10 to cause a servo signal generation circuit 83 to generate a signal for servo control and correct the deviation quantity via a servo control circuit 84.

Several optical system configurations and all the optical system configurations of the pickup 11, the cure optical system 13, and the disk rotation angle detection optical system 14 may be combined into one to be simplified.

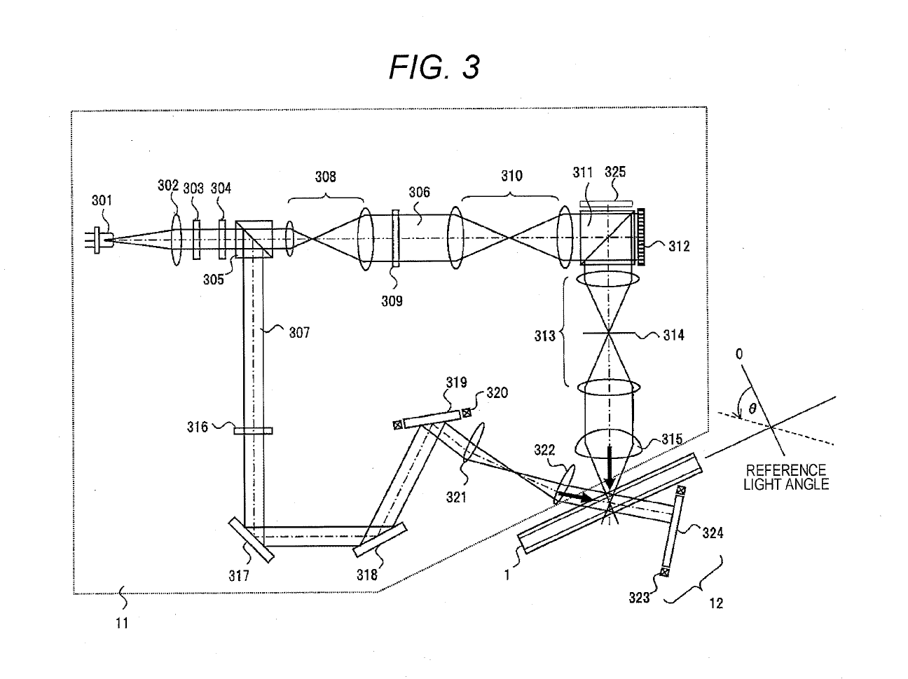

FIG. 3 illustrates recording principle in an example of basic optical system configuration of the pickup 11 in the optical information recording/reproduction device 10. The light beam emitted from the light source 301 passes through a collimate lens 302, and is incident upon a shutter 303. When the shutter 303 is open, the light beam passes through the shutter 303, and thereafter, the polarization direction is controlled by an optical device 304 constituted by, for example, a ½ wavelength plate so that the light quantity ratio of p polarization and s polarization becomes a desired ratio, and thereafter the light beam is incident upon a PBS (Polarization Beam Splitter) prism 305.

The light beam having passed through the PBS prism 305 serves as a signal light 306, and after the light beam diameter is enlarged by a beam expander 308, the light beam passes through a phase mask 309, a relay lens 310, and a PBS prism 311, and is incident upon a spatial light modulation device 312.

A signal light having information given thereto by the spatial light modulation device 312 is reflected by the PBS prism 311, and the signal light propagates through the relay lens 313 and the spatial filter 314. Thereafter, the signal light is condensed by the object lens 315 onto the optical information recording medium 1.

On the other hand, the light beam reflected by the PBS prism 305 serves as a reference light 307, and after the light beam is set in a predetermined polarization direction according to recording or reproduction by a polarization direction conversion device 316, the light beam is incident upon a galvano mirror 319 via a mirror 317 and a mirror 318. The angle of the galvano mirror 319 can be adjusted by an actuator 320, and therefore, the incidence angle of the reference light incident upon the optical information recording medium 1 after passing through the lens 321 and the lens 322 can be set to a desired angle. In order to set the incidence angle of the reference light, a device for converting the wave plane of the reference light may be used instead of the galvano mirror. In this specification, the reference light angle is such that, for example, as shown in the drawing, where a direction perpendicular to the optical information recording medium is zero degrees, a direction in which there is a larger scanning range of the reference light angle within a plane in which at least two or more reference lights of which angles are changed by the actuator 320 exist is defined as + direction, and the opposite direction is defined as − direction.

As described above, the signal light and the reference light are incident on the optical information recording medium 1 so that the signal light and the reference light overlap each other, whereby an interference fringe pattern is formed in the recording medium, and this pattern is written to the recording medium, so that the information is recorded. The galvano mirror 319 can change the incidence angle of the reference light incident upon the optical information recording medium 1, and therefore the information can be recorded by the angle multiplex.

Thereafter, in the hologram recorded by changing the reference light angle in the same area, a hologram corresponding to each reference light angle will be called a page, and a set of pages angle-multiplexed in the same area will be called a book.

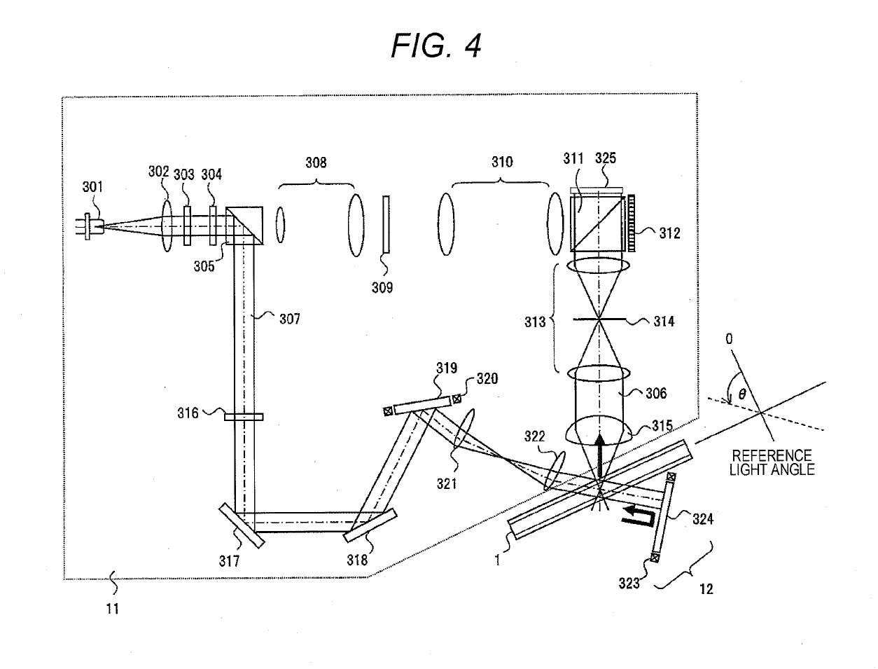

FIG. 4 illustrates a reproducing principle which is an example of a basic optical system configuration of the pickup 11 in the optical information recording/reproduction device 10. In a case where the recorded information is reproduced, the reference light is incident upon the optical information recording medium 1 as described above, and the light beam having passed through the optical information recording medium 1 is reflected by a galvano mirror 324 capable of adjusting the angle with the actuator 323, so that the reproduction reference light is generated.

The reproduction light reproduced by the reproduction reference light propagates the object lens 315, the relay lens 313, and the spatial filter 314. Thereafter, the reproduction light passes through the PBS prism 311, and is incident upon the light detection device 325, so that the recorded signal can be reproduced. The light detection device 325 may be an image-capturing device such as a CMOS image sensor and a CCD image sensor. But it may be any device as long as it can reproduce page data.

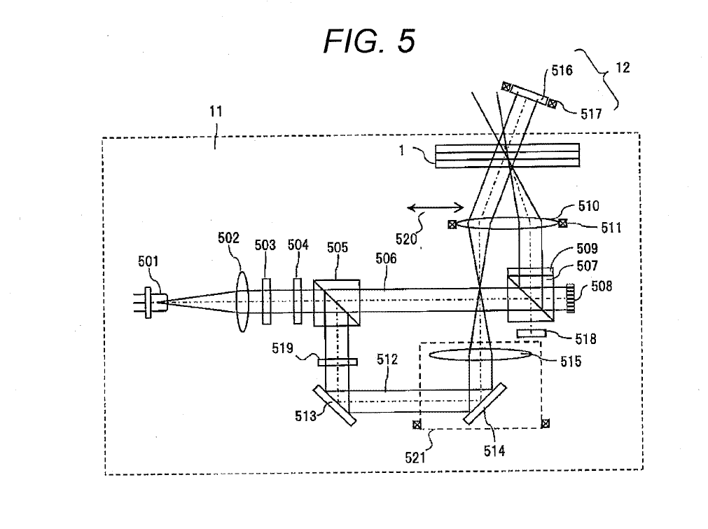

FIG. 5 is a figure illustrating another configuration of the pickup 11. In FIG. 5, the light beam which is output from a light source 501 passes through a collimate lens 502, and is incident upon a shutter 503. When the shutter 503 is open, the light beam passes through the shutter 503, and thereafter, the polarization direction is controlled by an optical device 504 constituted by, for example, a ½ wavelength plate so that the light quantity ratio of p polarization and s polarization becomes a desired ratio, and thereafter the light beam is incident upon a PBS prism 505.

The light beam having passed through the PBS prism 505 is incident upon a spatial light modulation device 508 by way of a PBS prism 507. A signal light 506 having information given thereto by the spatial light modulation device 508 is reflected by the PBS prism 507, and the signal light 506 propagates through an angle filter 509 that allows only light beam of a predetermined incidence angle to pass through. Thereafter, the signal light beam is condensed by the object lens 510 onto the hologram recording medium 1.

On the other hand, the light beam reflected by the PBS prism 505 serves as a reference light 512, and after the light beam is set in a predetermined polarization direction according to recording or reproduction by a polarization direction conversion device 519, the light beam is incident upon the lens 515 via the mirror 513 and the mirror 514. The lens 515 is configured to condense the reference light 512 onto the backfocus plane of the object lens 510, and the reference light once condensed on the backfocus plane of the object lens 510 is again made into parallel light by the object lens 510, and is incident upon the hologram recording medium 1.

In this case, the object lens 510 or optical block 521 can be driven, for example, in a direction indicated by reference sign 520, and the position of the object lens 510 or the optical block 521 is shifted along the driving direction 520, so that the relative position relationship changes between the object lens 510 and the focal point in the backfocus plane of the object lens 510, and therefore, the incidence angle of the reference light incident upon the hologram recording medium 1 can be set in a desired angle. Instead of driving the object lens 510 or the optical block 521, the incidence angle of the reference light may be set in a desired angle by driving the mirror 514 with the actuator.

As described above, the signal light and the reference light are incident on the hologram recording medium 1 so that the signal light and the reference light overlap each other, whereby an interference fringe pattern is formed in the recording medium, and this pattern is written to the recording medium, so that the information is recorded. The position of the object lens 510 or the optical block 521 is shifted along the driving direction 520, whereby the incidence angle of the reference light incident upon the hologram recording medium 1 can be changed, and therefore the information can be recorded by the angle multiplex.

When the recorded information is reproduced, the reference light is incident upon the hologram recording medium 1 as described above, and the light beam having passed through the hologram recording medium 1 is reflected by the galvano mirror 516, whereby the reproduction reference light is generated. The reproduction light reproduced by the reproduction reference light propagates through the object lens 510 and the angle filter 509. Thereafter, the reproduction light passes through the PBS prism 507, and is incident upon the light detection device 518, so that the recorded signal can be reproduced.

The optical system as shown in FIG. 5 is configured such that the signal light and the reference light are incident upon the same object lens, and there is an advantage in that the size of the optical system can be greatly reduced in contrast to the optical system configuration as shown in FIG. 3.

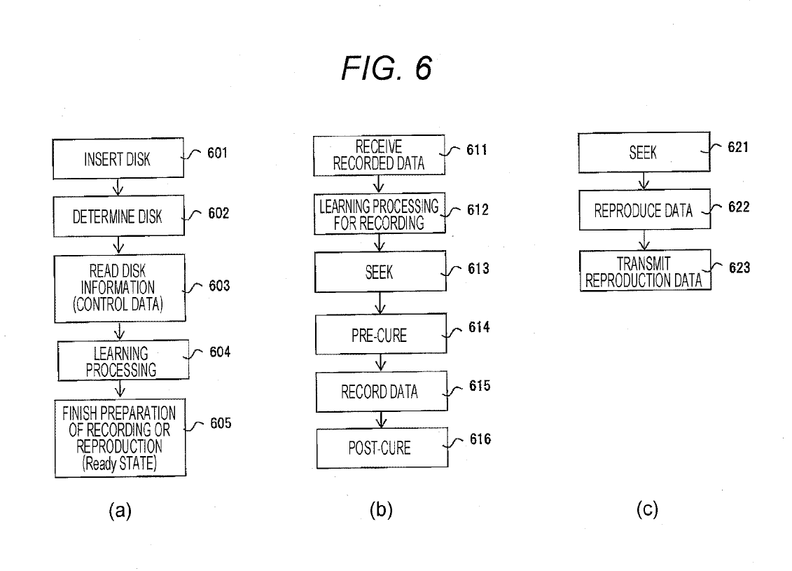

FIGS. 6(a) to 6(c) illustrate an operation flow of recording and reproduction in the optical information recording/reproduction device 10. In this case, in particular, a flow of recording/reproduction using holography will be explained.

FIG. 6(a) is an operation flow from when the optical information recording medium 1 is inserted into the optical information recording/reproduction device 10 and to when the preparation for the recording or the reproduction is completed. FIG. 6(b) illustrates an operation flow from the preparation completion state to when information is recorded to the optical information recording medium 1. FIG. 6(c) illustrates an operation flow from the preparation completion state to when the information recorded on the optical information recording medium 1 is reproduced.

When the medium is inserted as shown in FIG. 6(a) (601), the optical information recording/reproduction device 10 performs disk determination as to whether, for example, the inserted medium is a medium for recording or reproducing digital information using holography (602).

When the medium is determined to be an optical information recording medium for recording or reproducing digital information using holography as a result of the disk determination, the optical information recording/reproduction device 10 reads control data provided in the optical information recording medium (603), for example, the optical information recording/reproduction device 10 obtains information about the optical information recording medium, and for example, information about various kinds of setting conditions during recording and reproduction.

After the control data are read, various kinds adjustment according to the control data and learning processing of the pickup 11(604) are performed, and the optical information recording/reproduction device 10 finishes the preparation of recording or reproducing (605).

In the operation flow from the preparation completion state to when the information is recorded, first, as shown in FIG. 6(b), data to be recorded are received (611), and the information according to the data is sent to the spatial light modulation device in the pickup 11.

Thereafter, in order to record high quality information to an optical information recording medium, various kinds of learning processing for recording such as the power density optimization of the light source 301 and the optimization of the exposure light time with the shutter 303 are performed in advance as necessary (612).

Thereafter, in the seek operation (613), the access control circuit 81 is controlled to move the position of the pickup 11 and the cure optical system 13 to a predetermined position of the optical information recording medium. In a case where the optical information recording medium 1 has address information, the address information is reproduced, and the following operation is repeated: a determination is made as to whether the position has been moved to the target position, and if the position is not arranged at the target position, the deviation quantity from the predetermined position is calculated, and the positioning is performed again.

Thereafter, a predetermined area is pre-cured using the light beam emitted from the cure optical system 13 (614), and the reference light and the signal light emitted from the pickup 11 are used to record the data (615).

After the data are recorded, the post-cure is performed using the light beam emitted from the cure optical system 13 (616). As necessary, the data may be verified.

In the operation flow from the reparation completion, state to when the recorded information is reproduced, as shown in FIG. 6(c), first, in the seek operation (621), the access control circuit 81 is controlled, and the positions of the pickup 11 and the reproduction reference light optical system 12 are moved to a predetermined position of the optical information recording medium. In a case where the optical information recording medium 1 has address information, the address information is reproduced, and the following operation is repeated: a determination is made as to whether the position has been moved to the target position, and if the position is not arranged at the target position, the deviation quantity from the predetermined position is calculated, and the positioning is performed again.

Thereafter, the reference light is emitted from the pickup 11, and information recorded in the optical information recording medium is read out (622), and the reproduction data are transmitted (613).

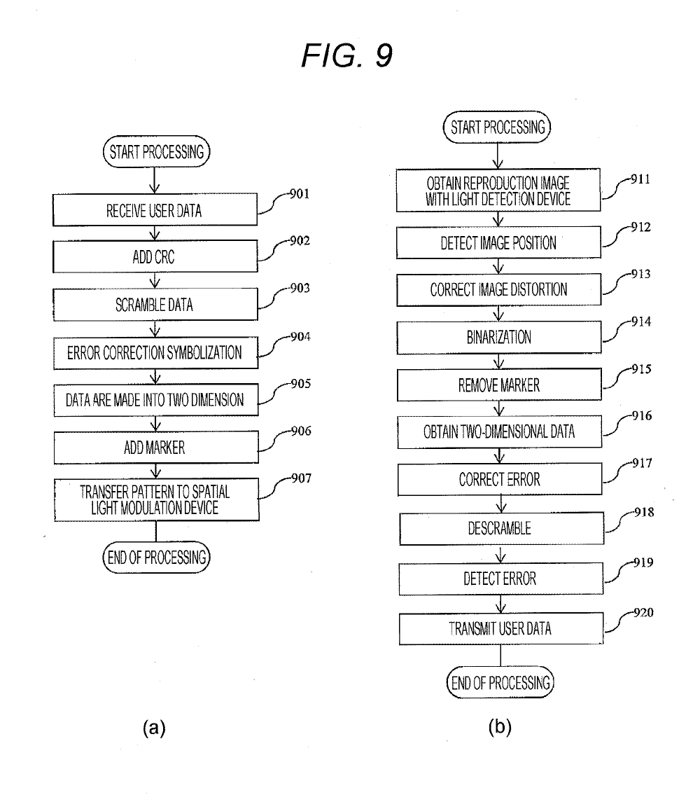

FIGS. 9(a) and 9(b) illustrate a data processing flow during recording and reproduction. FIG. 9(a) illustrates a recording data processing flow of the signal generation circuit 86 from the recording data reception 611 with the input/output control circuit 90 to the conversion into two-dimensional data on the spatial light modulation device 312. FIG. 9(b) illustrates a reproduction data processing flow with the signal processing circuit 85 from the detection of the two-dimensional data with the light detection device 325 to the reproduction data transmission 624 with the input/output control circuit 90.

The data processing during recording will be explained with reference to FIG. 9(a). When user data are received (901), the user data are divided into multiple data rows, and each data row is attached with CRC so as to allow error detection during reproduction (902), and the number of ON pixels and the number of OFF pixels are caused to be substantially the same, and scramble (903) is applied to add a pseudo random number data row to the data row in order to prevent the same pattern from being repeated, and thereafter, error correction symbolization (904) such as Reed-Solomon symbol to allow for error correction during reproduction. Subsequently, this data row is converted into M×N two-dimensional data, and this is repeated for the data for one page, so that two-dimensional data for one page (905) is made. As described above, a marker serving as reference in the image position detection and the image distortion correction during reproduction is added to the made two-dimensional data (906), and the data are transferred to the spatial light modulation device 312 (907).

Subsequently, a data processing flow during reproduction will be explained with reference to FIG. 9(b). The image data detected by the light detection device 325 are transferred to the signal processing circuit 85 (911). The image position is detected on the basis of the marker included in the image data (912), and after distortion such as inclination, magnification rate, and distortion of the image is corrected (913), the binarization processing (914) is performed, and the marker is removed (915), so that two-dimensional data for one page are obtained (916). The two-dimensional data thus obtained are converted into multiple data rows, and thereafter, error correction processing (917) is performed, whereby the parity data row is removed. Subsequently, the scramble cancellation processing (918) is performed, and the error detection processing based on CRC (919) is performed to remove the CRC parity, and thereafter, the user data are transmitted via the input/output control circuit 90 (920).

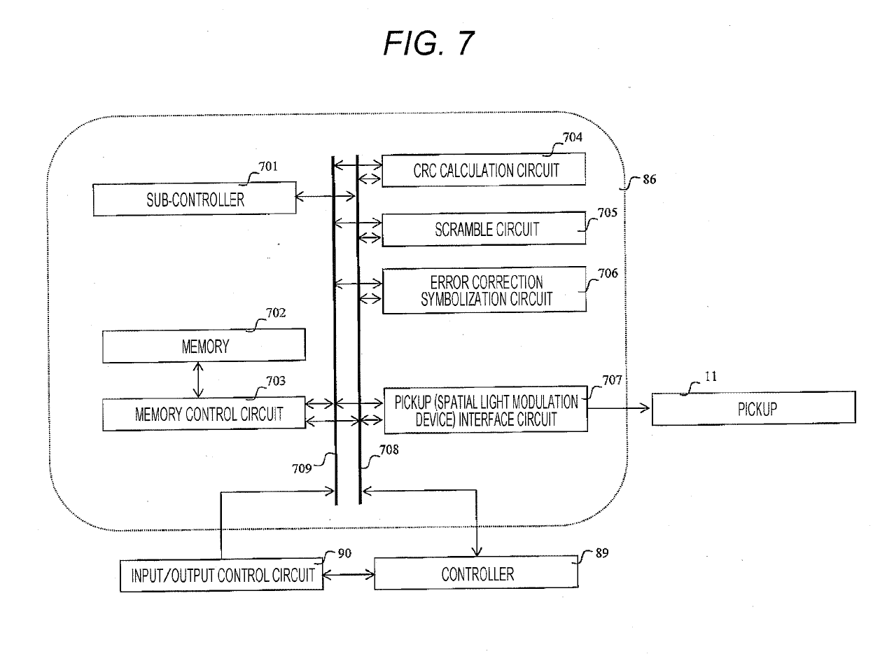

FIG. 7 is a block diagram illustrating the signal generation circuit 86 of the optical information recording/reproduction device 10.

When the output control circuit 90 starts input of the user data, the input/output control circuit 90 notifies the controller 89 that the input of the user data is started. The controller 89 receives this notification, and commands the signal generation circuit 86 to perform recording processing to record data for one page which are input from the input/output control circuit 90. The processing command given by the controller 89 passes through a control line 708, and notified to a sub-controller 701 in the signal generation circuit 86. Upon receiving this notification, the sub-controller 701 controls each signal processing circuit via the control line 708 so as to cause each signal processing circuit to operate in parallel. First, the memory control circuit 703 is controlled to store the user data, which are input via the data line 709 from the input/output control circuit 90, to the memory 702. When a certain quantity of user data is stored in the memory 702, control is performed to cause the CRC calculation circuit 704 to attach CRC to the user data. Subsequently, control is performed so that a scramble circuit 705 scrambles the data with CRC by adding a pseudo random number data row, and an error correction symbolization circuit 706 performs error correction symbolization to add a parity data row. Finally, a pickup interface circuit 707 reads the data applied with the error correction symbolization from the memory 702 in the order of the arrangement of the two-dimensional data on the spatial light modulation device 312, and a marker serving as the reference during reproduction is added, and thereafter, the two-dimensional data are transferred to the spatial light modulation device 312 in the pickup 11.

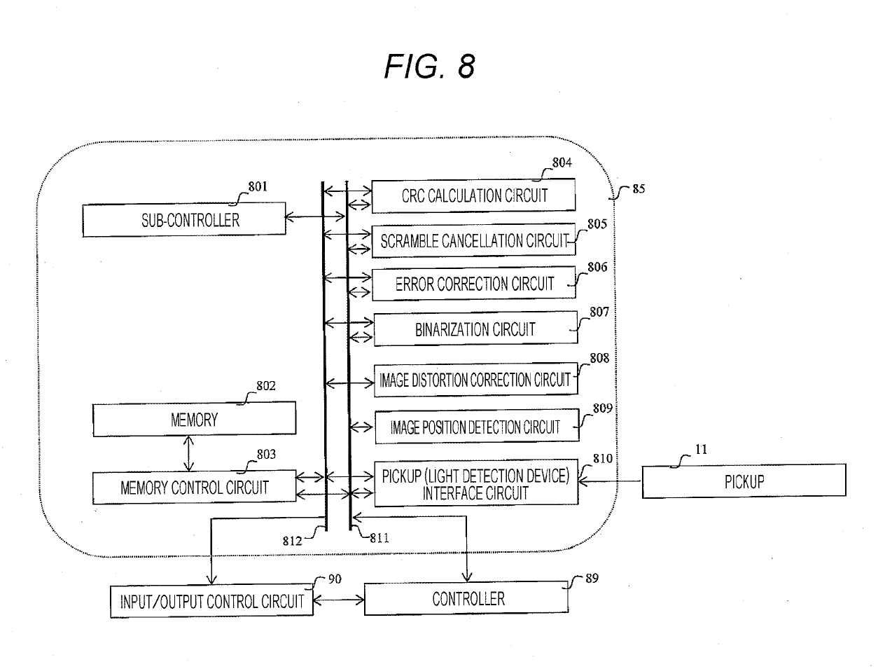

FIG. 8 is a block diagram illustrating the signal processing circuit 85 of the optical information recording/reproduction device 10.

When the light detection device 325 in the pickup 11 detects image data, the controller 89 commands the signal processing circuit 85 to perform reproducing processing to reproduce data for one page which are input from the pickup 11. The processing command from the controller 89 passes through the control line 811, and is notified to the sub-controller 801 in the signal processing circuit 85. Upon receiving this notification, the sub-controller 801 controls each signal processing circuit via the control line 811 to cause the signal processing circuits to operate in parallel. First, the memory control circuit 803 is controlled to store the image data, which are input via the data line 812 from the pickup 11 by way of the pickup interface circuit 810, to the memory 802. When a certain quantity of data are stored in the memory 802, control is performed to cause an image position detection circuit 809 to detect a marker from the image data stored in the memory 802 to extract an effective data range. Subsequently, control is performed to cause an image distortion correction circuit 808 to correct distortion such as inclination, magnification rate, and distortion of the image using the detected marker, and the image data are converted into an expected size of two-dimensional data. Then, control is performed to cause a binarization circuit 807 to perform binarization to determine “0” and “1” in each bit data of multiple bits constituting the two-dimensional data of which size has been converted, and the data are stored in the order of output of the reproduction data to the memory 802. Subsequently, the error correction circuit 806 corrects errors included in each data row, and the scramble cancellation circuit 805 descrambles the data with the pseudo random number data row, and thereafter, the CRC calculation circuit 804 confirms that no error is included in the user data on the memory 802. Thereafter, the user data are transferred to the input/output control circuit 90 from the memory 802.

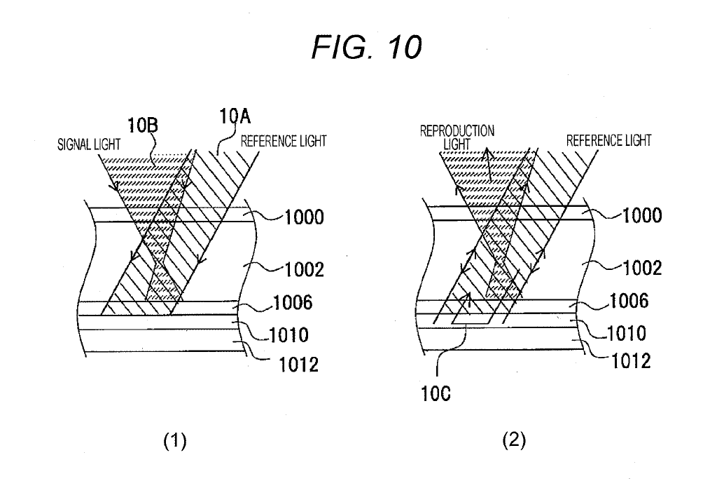

FIGS. 10(1) and 10(2) are figures illustrating a layer structure of an optical information recording medium having a reflection layer. FIG. 10(1) illustrates the state in which information is recorded to the optical information recording medium. FIG. 10(2) illustrates the state in which information is reproduced from the optical information recording medium.

The optical information recording medium 1 has a transparent cover layer 1000, a recording layer 1002, a light absorption/light passing layer 1006, a light reflection layer 1010, and a third transparent protective layer 1012, which are arranged from the light pickup 11. An interference pattern of the reference light 10A and the signal light 10B is recorded to the recording layer 1002.

The light absorption/light passing layer 1006 changes the physical property so as to absorb the reference light 10A and the signal light 10B during information recording and pass the reference light during information reproducing. For example, a voltage is applied to the light recording medium 1, whereby the colored and decolored state of the light absorption/light passing layer 1006 changes, and more specifically, during information recording, the light absorption/light passing layer 1006 is in the colored state, so that the reference light 10A and the signal light 10B having passed the recording layer 1002 are absorbed, and during information reproducing, the light absorption/light passing layer 1006 is in the decolored state, so that the reference light is allowed to pass therethrough (T. Ando et. al.: Technical Digest ISOM (2006), Th-PP-10). The reference light 10A having passed through the light absorption/light passing layer 1006 is reflected by the light reflection layer 1010 to become the reproduction reference light 10C.

WO3 serving as electrochromic (EC) material described in A. Hirotsune et. al.: Technical Digest ISOM (2006), Mo-B-04 may be used as the light absorption/light passing layer 1006.

The colored and decolored states are caused in a reversible manner by applying a voltage to the material, and during information recording, the light is absorbed in the colored state, and during information reproducing, the light is passed in the decolored state.

With the configuration in FIG. 10, the reproduction reference light optical system is unnecessary, and the size of the drive can be reduced.

Here, the inventors will explain, in details, a technique for adjusting the recording condition in a holographic memory.

FIG. 20 is a schematic diagram illustrating an example of relationship of a recording exposure light energy density and a reference light angle in an optical information recording/reproduction device. In the holographic memory, the recording energy density needs to be changed depending on the reference light angle in view of, e.g., change in the sensitivity of the optical information recording medium, difference in the light usage efficiency depending on the reference light angle, and difference in the noise quality depending on the reference light angle. In the example as shown in FIG. 20, the recording exposure light energy density is increased in an area where the reference light angle is low, and the recording exposure light energy density is decreased in an area where the reference light angle is high. The optimum shape of the waveform changes depending on, e.g., the environment such as the temperature and the humidity during recording, the configuration of the used optical information recording/reproduction device, the characteristics of the optical information recording medium, and the format of book arrangement, and therefore, the technique for adjusting the recording condition is important. In the explanation below, this waveform indicating the relationship between the recording exposure light energy density and the reference light angle will be referred to as scheduling waveform.

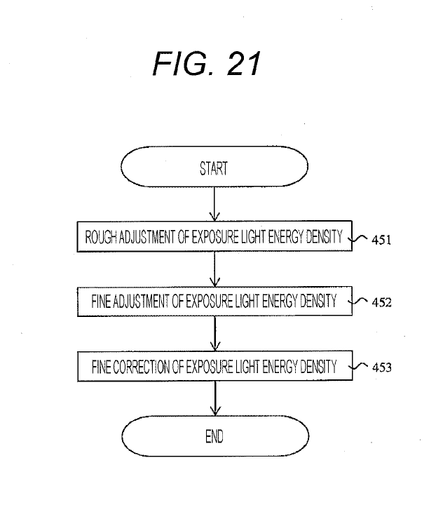

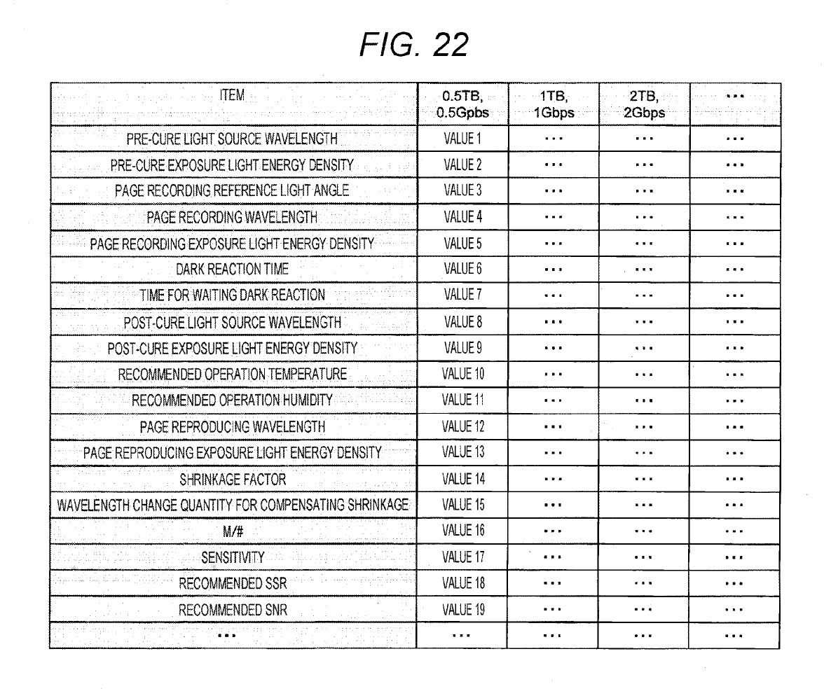

FIG. 21 is a schematic diagram illustrating an embodiment of an overall flow of a recording condition adjustment in an optical information recording/reproduction device. First, in 451, the exposure light energy density is roughly adjusted. The rough adjustment of the exposure light energy density is to roughly determine a shape of the scheduling waveform, and, for example, it is realized by a method according to a second embodiment. Thereafter, in 452, the exposure light energy density is finely adjusted. The fine adjustment of the exposure light energy density is to perform fine adjustment of the shape of the scheduling waveform on the basis of the scheduling waveform determined in 451, and, for example, it is realized by a method according to this first embodiment, for example. Finally, in 453, the exposure light energy density is finely corrected. The fine correction of the exposure light energy density is to correct the exposure light energy density during the user data recording, e.g., when the recording environment changes or when the recording quality changes, and, for example, it is realized by the method according to the third embodiment or the fourth embodiment. It should be noted that the optical information recording/reproduction device may perform all of the three processing explained above, or may perform only necessary processing. Each processing is not limited to the methods of the embodiments mentioned above as an example. For example, the rough adjustment of the exposure light energy density in 451 is not limited to the second embodiment, and may be achieved by the first embodiment, the third embodiment, or other methods. The flow in FIG. 21 is operated, for example, by a recording condition adjustment circuit 92 explained below.

FIG. 1 is a schematic diagram illustrating an embodiment of a recording condition adjustment circuit in the optical information recording/reproduction device. A buffer memory 401 in the recording condition adjustment circuit 92 inputs the reproduction signal from the pickup 11, and outputs the reproduction signal to a Signal detection circuit 402 and a Scatter detection circuit 403. The Signal detection circuit 402 calculates Signal values of the page data from information about the reproduction signal received from the buffer memory 401, and outputs the Signal values to the SSR calculation circuit 404 and the exposure light energy density calculation circuit 406. The Scatter detection circuit 403 calculates Scatter values of the page data from information about the reproduction signal received from the buffer memory 401, and outputs the Scatter values to the SSR calculation circuit 404 and the target Signal calculation circuit 405. The SSR calculation circuit 404 inputs a Signal value from the Signal detection circuit 402 and a Scatter value from the Scater detection circuit 403, calculates an SSR (Signal to Scatter Ratio), and outputs the SSR to the target Signal calculation circuit 405. The detailed explanation about the Signal, the Scatter, and the SSR will be explained later. The target Signal calculation circuit 405 inputs the SSR values and the Scatter values, and in a case where, for example, the SSR values of all the pages vary greatly or the SSR values are low, then, the target Signal value is calculated, and is output to the exposure light energy density calculation circuit 406. The exposure light energy density calculation circuit 406 inputs the Signal value and the target Signal value, calculates the exposure light energy density with which the page data indicating the target Signal are recorded, and outputs the exposure light energy density to the controller 89.

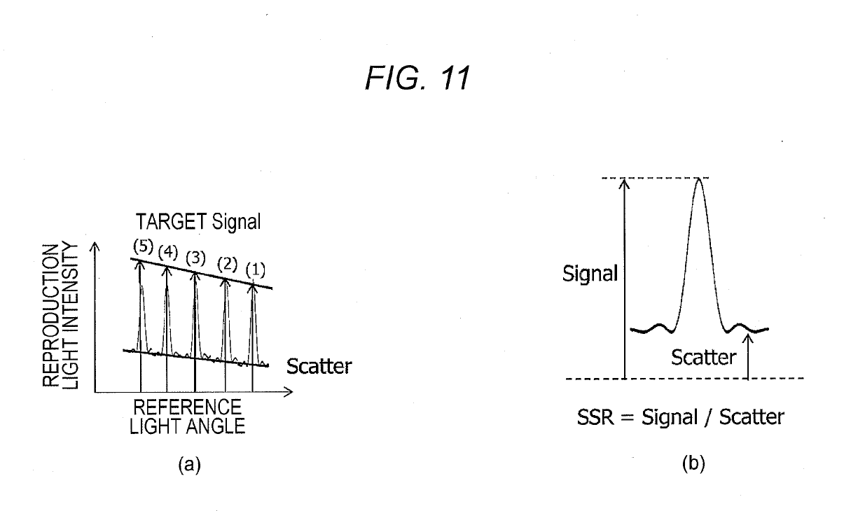

FIG. 11(a) is a schematic diagram illustrating an example of relationship of a reproduction light intensity and a reference light angle in the same book in the optical information recording/reproduction device. FIG. 11(b) illustrates a partially enlarged view thereof. FIG. 11(a) illustrates an example where five pages of data are recorded or reproduced from a larger reference light angle to a smaller reference light angle. However, six or more pages may be recorded or reproduced. As shown in FIG. 11(b), the Signal value of each piece of page data indicates the maximum value of the intensity when the reference light angle is changed, and the Scatter value indicates the minimum value. In the calculation of the Signal value and the Scatter value, for example, as shown in FIG. 11(b), the relationship diagram of the reproduction light intensity and the reference light angle is divided into portions corresponding to one page, and among them, the maximum value is adopted as the Signal value, and the minimum value is adopted as the Scatter value. The SSR (signal-to-scatter ratio, which is applicable to below) is a ratio between the Signal value and the Scatter value, and can be expressed by the following expression (Expression 1).

SSR=Signal/Scatter (Expression 1)

It should be noted that the ratio of the values obtained by subtracting the camera output value when the light is not input from the Signal value and the Scatter value may be defined as the SSR. In this case, where the camera output value when the light is not input is denoted as I, the SSR can be expressed by the following expression (Expression 2).

SSR=(Signal−I)/(Scatter−I) (Expression 2)

The target Signal explained above is, for example, a Signal value such that all the pages attain the target SSR under the calculated Scatter values, and is expressed by the following expression (Expression 3) or (Expression 4). The Scatter value is a different value for each page, and accordingly, the target Signal value is a different value for each page.

target Signal=target SSR×Scatter (Expression 3)

target Signal=target SSR×(Scatter−I)+I (Expression 4)

In the calculation of the Signal and the Scatter, all the pages may be scanned as shown in FIG. 11(a), or every several pages may be scanned considering that the characteristics of adjacent pages are substantially the same, or the Signal values or the Scatter values of all the pages may be calculated from linear interpolation from the Signal values or the Scatter values derived from every several pages or nonlinear interpolation by using an approximated curve and the like.

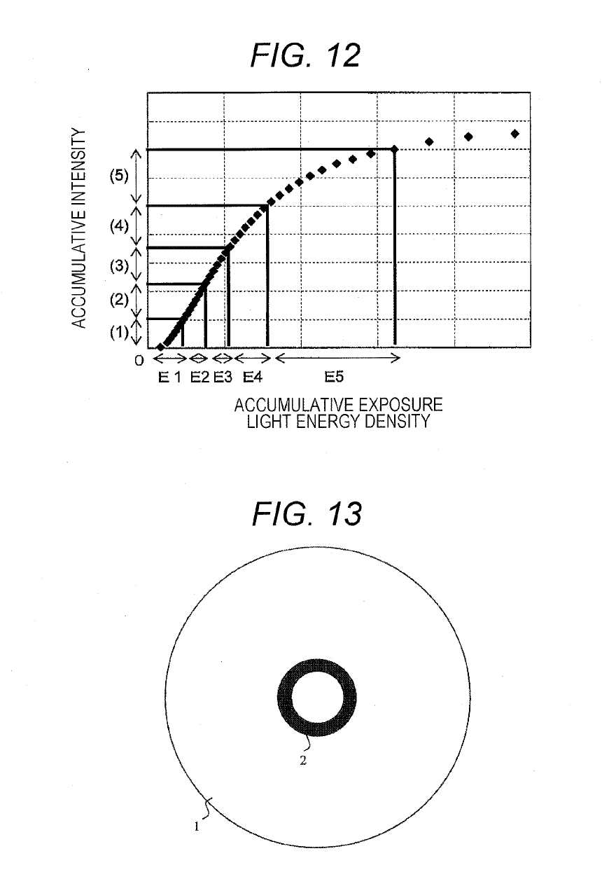

FIG. 12 is a schematic diagram illustrating an example of relationship of an accumulative intensity and an accumulative exposure light energy density in the optical information recording/reproduction device. The accumulative exposure light energy density in the horizontal axis denotes the total summation of the exposure light energy density to the optical information recording medium during recording. The accumulative intensity in the vertical axis denotes the total summation of the reproduction light intensity during reproduction. For example, in the determination method for determining exposure light energy densities E1 to E5 for recording pages of target Signal values (1) to (5) as shown in FIGS. 11(a) and 11(b), the vertical axis is successively divided with the target Signal values (1) to (5) as shown in FIG. 12, and the exposure light energy densities E1 to E5 are successively calculated from the values obtained by drawing vertical lines from the crossing points of the graph to the horizontal axis at this occasion. In this operation, for example, an approximated curve of relationship between the accumulative intensity and the accumulative exposure light energy density may be made into a formula, and the values of E1 to E5 may be derived by calculation based on the values of (1) to (5). In FIG. 12, the vertical axis represents the total summation of the reproduction light intensity, but the vertical axis may represent the total summation of the diffraction efficiency, or a so-called M/# (M number) which is the total summation of the diffraction efficiency to the ½-th power, or the total summation of the reproduction light intensity to the ½-th power. The angle interval of each page is preferably an angle interval when the user data are actually recorded or reproduced, but the angle interval of each page is not necessarily limited to an angle interval when the user data are recorded or reproduced. In this case, M/# is defined by the following expression, and is an index representing the dynamic range of the optical information recording medium. η denotes a diffraction efficiency. Σ is calculation of a summation for the number of multiplex until the diffraction efficiency converges to substantially the minimum value.

M/#=Ση (Expression 5)

FIG. 13 is a schematic diagram illustrating an embodiment of an optical information recording medium. For example, in a case where the recording condition is adjusted before the user data are recorded, the above method is done in the adjustment area 2 provided on the optical information recording medium 1. The exposure light energy density calculated after the adjustment may be saved in, for example, an optical information recording medium, a cartridge storing an optical information recording medium, an optical information recording/reproduction device, or a device controlling an optical information recording/reproduction device. In FIG. 13, for example, a single adjustment area is provided in a recording medium inner peripheral portion. However, it is not limited to the inner peripheral portion. Multiple adjustment areas may be provided at any locations in the medium.

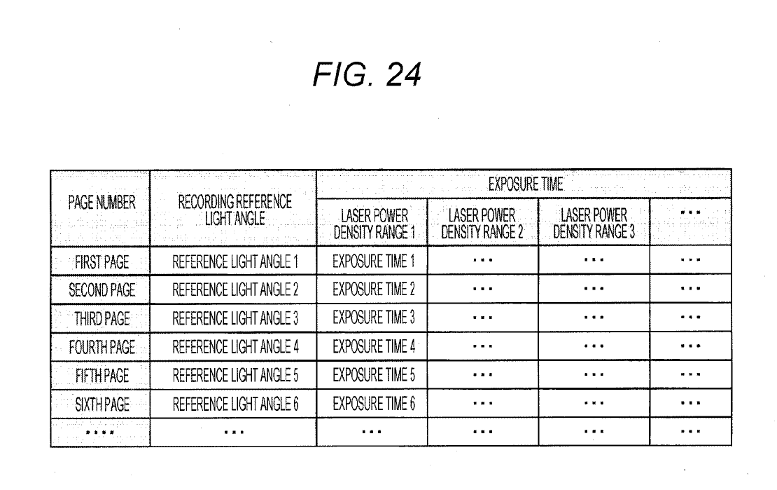

The saved location of the exposure light energy density used during recording after the adjustment may be provided on an optical information recording medium separately from the adjustment area. The adjustment may be done on every occasion before recording, or only when a disk is replaced, or every time a predetermined recording time or the number of times of recording is attained, or only when the change in the environment such as the temperature and the humidity is detected and a great change occurs. Information about the recording condition such as the signal-to-scatter ratio and the exposure light energy density suitable for recording the optical information recording medium, the exposure light power density, the exposure light time, the time for waiting the dark reaction, the exposure light energy density for pre-cure, the exposure light energy density for post-cure, and the like may be saved, before shipment, in an optical information recording medium or a cartridge storing an optical information recording medium. For example, the recording reference light angle of each page and the exposure light time for the laser power density are saved in an optical information recording medium and the like in the configuration as shown in FIG. 24. The laser power density may be constant, and the relationship of the exposure light time and the recording reference light angle may be saved as a table, or the exposure light time may be constant, and the relationship of the laser power density and the recording reference light angle may be saved as a table.

Information about the recording condition may be saved in an optical information recording/reproduction device or a device for controlling an optical information recording/reproduction device. The optical information recording/reproduction device may record user data by using information about the recording condition, or may first refer to the information about the recording condition, and adjust the recording condition according to the above method, and thereafter, record the user data.

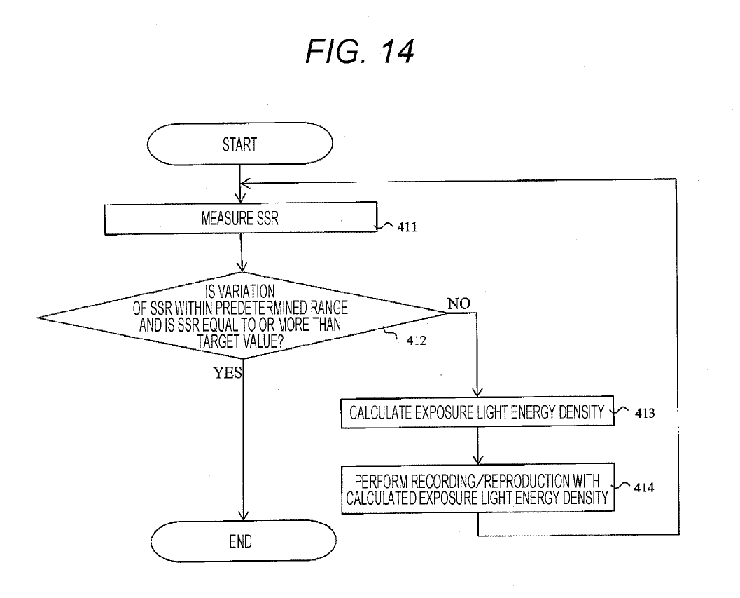

FIG. 14 is a schematic diagram illustrating an embodiment of an operation flow of a recording condition adjustment in the recording condition adjustment circuit 92 of the optical information recording/reproduction device. During the recording condition adjustment, for example, in 411, first, the SSR is measured. In 412, a determination is made as to whether variation of the SSRs of the pages is within a predetermined range (desirably, the SSRs of each page is substantially constant) or not and a determination is made as to whether the SSR is equal to or more than the target value. When the variation of the SSRs is determined to be within the predetermined range and the SSR is determined to be equal to or more than the target value in 412, the processing is terminated. When the variation of the SSRs is determined not to be within the predetermined range and the SSR is determined to be equal to or less than the target value in 412, the exposure light energy density is calculated according to, for example, the above method in 413. Thereafter, in 414, the recording/reproduction is carried out with the calculated exposure light energy density, and the processing is performed from 411 again. In step 412, not only the determination is made as to whether variation of the SSRs is within the predetermined range but also the determination is made as to whether the SSR is equal to or more than the target value. However, the present invention is not limited thereto. Any one of the determination is made as to whether variation of the SSRs is within the predetermined range or the determination is made as to whether the SSR is equal to or more than the target value may be performed. Before the recording condition adjustment is started, the two-dimensional signal is recorded to the adjustment area using the predetermined recording condition (for example, information about any given recording condition as shown in FIG. 22), but for example, when the management information and the user data are already recorded to the optical information recording medium, and when the environment during recording such as the temperature and the humidity and the laser coherency during the recording condition adjustment is determined to be substantially the same as the environment during user data recording and the management information, a part of the area where the user data and the management information are recorded may be treated as an adjustment area, and the recording condition adjustment may be performed.

In the method according to the present embodiment, the recording condition is adjusted under the same condition as the condition when the user data are actually recorded or a condition similar thereto, and therefore, there is an advantage in that more suitable recording condition can be calculated.

The SSRs of all the pages are equal to or more than the target value, so that the high quality hologram can be recorded, and a high quality signal can be obtained during reproduction.

The variation of SSRs between different pages is within the predetermined range (desirably, the SSRs of the pages are substantially the same), so that the limited M/# of the optical information recording medium can be effectively distributed to the pages, and not only the number of multiplex but also the recording capacity can be improved. The SNRs between the pages are equal, and therefore, for example, the servo signal can be generated by using the difference of the SNRs between pages, and in addition, the reference light angle compensation accuracy and the like during reproduction can be improved.

In the explanation below, explanation about the same contents as the present embodiment is omitted.

### Second Embodiment

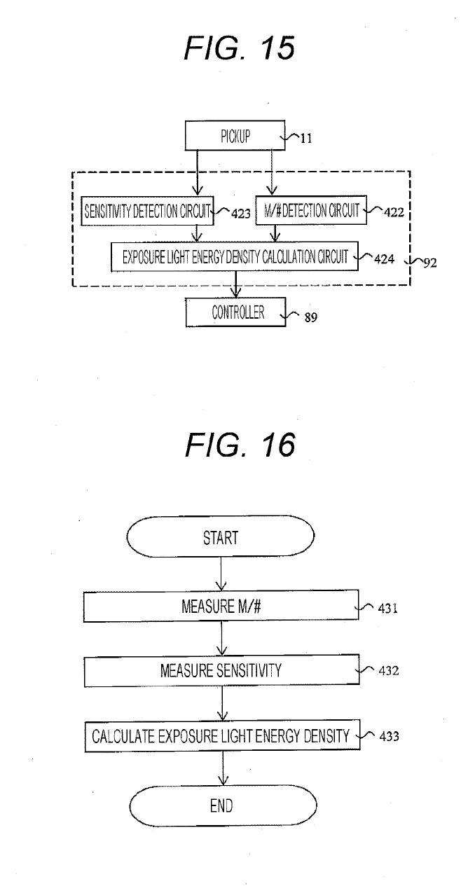

A second embodiment of the present invention will be explained with reference to FIGS. 15 and 16.

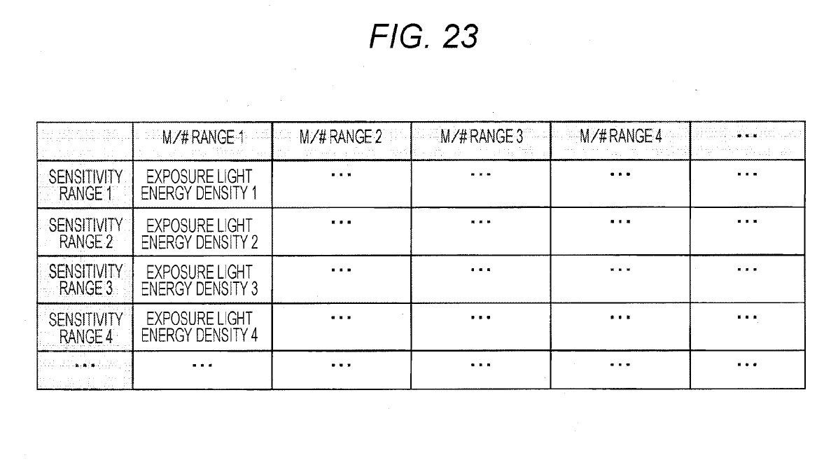

FIG. 15 is a schematic diagram illustrating an embodiment of the recording condition adjustment circuit in the optical information recording/reproduction device. An M/# detection circuit 422 in a recording condition adjustment circuit 92 inputs a reproduction signal from the pickup 11, detects M/# of the optical information recording medium, and outputs M/# to an exposure light energy density calculation circuit 424. A sensitivity detection circuit 423 inputs a reproduction signal from the pickup 11, detects the sensitivity of the optical information recording medium, and outputs it to the exposure light energy density calculation circuit 424. The exposure light energy density calculation circuit 424 inputs M/# and sensitivity of the optical information recording medium, calculates the exposure light energy density, and outputs the exposure light energy density to a controller 89. In the exposure light energy density calculation method, for example, the table or the calculation expression of the exposure light energy density determined from M/# and the sensitivity are possessed by the exposure light energy density calculation circuit 424 in advance, and the exposure light energy density is determined from the information about M/# and the sensitivity measured before the user data recording. For example, the exposure light energy densities of multiple optical information recording media having different M/# and sensitivities are generated in advance according to the method using SSR as the index shown in the first embodiment, and for example, the table is saved as a table of the exposure light energy density determined from M/# and the sensitivity shown in FIG. 23 and saved in an optical information recording/reproduction device, a device for controlling an optical information recording/reproduction device, an optical information recording medium, or a cartridge storing an optical information recording medium. This table may not save the exposure light energy density, and may save the exposure light time, the laser power density, or a combination thereof.

For example, the exposure light energy densities of multiple optical information recording media having different M/# and sensitivities are generated in advance according to the method using SSR as the index shown in the first embodiment, and the calculation expression of the exposure light energy density determined from M/# and the sensitivity is calculated using, for example, an approximation method and the like, and the calculation expression is saved in the optical information recording/reproduction device. Alternatively, an expression theoretically derived may be saved as the calculation expression in the information recording/reproduction device. The sensitivity is defined by the following expression, and is obtained by dividing M/# multiplied by 0.8 by the energy density required for recording consuming M/# multiplied by 0.8.

sensitivity=0.8×M/#/(energy density required for recording of M/# multiplied by 0.8) (Expression 6)

FIG. 16 is a schematic diagram illustrating an embodiment of an operation flow of recording condition adjustment in the recording condition adjustment circuit 92 of the optical information recording/reproduction device. During the recording condition adjustment, first, in 431, M/# is measured in the adjustment area on the optical information recording medium. Thereafter, in 432, likewise, the sensitivity of the optical information recording medium is measured in the adjustment area. Thereafter, in 433, the exposure light energy density is calculated. The measurement of M/# and the sensitivity may be calculated using the same reproduction data, or different reproduction data may be used. The recording data during measurement of M/# and the sensitivity may be recorded with the same angle interval as the angle interval when the user data are actually recorded, or may be recorded with an angle interval different therefrom. The configuration of the pages may be the same configuration as the configuration when the user data are actually recorded, or a different page configuration may be used, or a so-called white page in which all the pixels are in the ON state may be used.

The method according to the present embodiment can be realized with a smaller circuit scale or eliminates the necessity to perform repetition processing as compared with the method according to the first embodiment, and there is an advantage in that the adjustment time is shorter.

Even with the same type of optical information recording media, M/# and/or the sensitivity are slightly different depending on each optical information recording medium, and therefore, before recording, M/# and/or the sensitivity are measured, and the exposure light energy is determined in accordance with the measurement result, so that there is an advantage in that M/# and/or the sensitivity for each optical information recording medium can cope with the difference.

In the explanation below, explanation about the same contents as the present embodiment is omitted.

In the present embodiment, the configuration for determining the exposure light energy density on the basis of M/# and the sensitivity has been explained. The present invention is not limited thereto. As necessary, the exposure light energy density may be determined on the basis of any one of M/# and the sensitivity.

### Third Embodiment

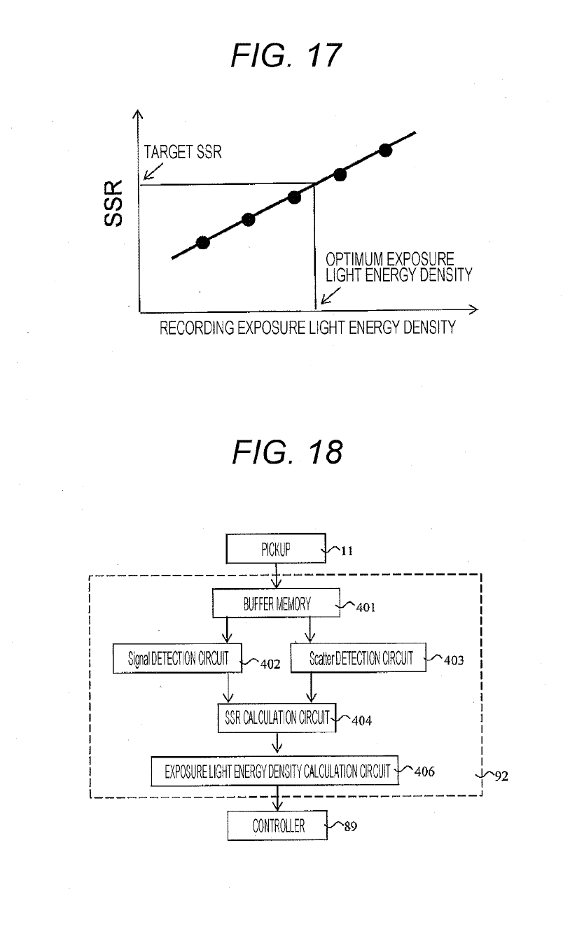

A third embodiment according to the present invention will be explained with reference to FIGS. 17 to 19.

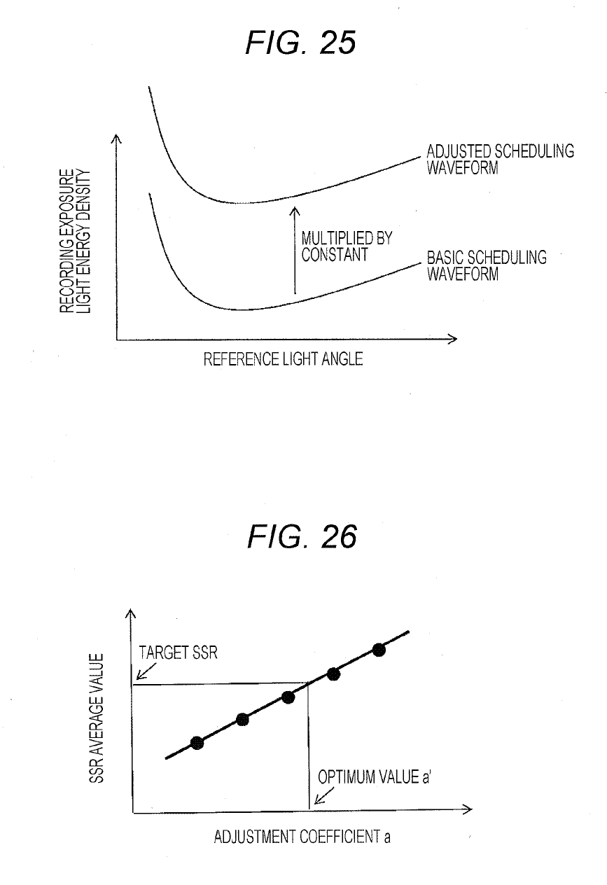

In the present embodiment, for example, when there is a change in the environment such as the temperature, the humidity, and the laser coherency during recording, the basic scheduling waveform generated in the method according to the second embodiment is finely corrected by multiplying it by a constant as shown in FIG. 25, whereby the basic scheduling waveform is corrected.

FIG. 17 is a schematic diagram illustrating an example of relationship of SSR and recording exposure light energy density in the optical information recording/reproduction device. During adjustment of the recording condition according to the present embodiment, multiple page data are recorded to the same book with different reference light angles, while the exposure light energy density is changed, in the adjustment area on the optical information recording medium. Thereafter, the SSR is calculated from the reproduction data of the page data, and the relationship between the exposure light energy density and the SSR during recording is calculated as shown in FIG. 17. In this case, each point in FIG. 17 corresponds to a case of recording with each different reference light angle. At this occasion, for example, the exposure light energy density with which the page data of the target SSR are recorded is derived by using an expression of an approximated curve of a graph or linear interpolation. Thereafter, for example, the optimum exposure light energy density for recording each page is derived using the following expression. In this case, Eₙ′ denotes the n-th page exposure light energy density after optimization, and Eₙ denotes the n-th page exposure light energy density before optimization, and A′ denotes the exposure light energy density with which the page data of the target SSR are recorded, and A denotes an average value, over all the pages, of the exposure light energy density before the optimization.

Eₙ′=Eₙ×A′/A (Expression 7)

The SSR is used as an index, for example. Alternatively, it is not limited to the SSR. For example, the SNR (signal-to-noise ratio), the reproduction light intensity, the reproduction light intensity to the ½-th power, the diffraction efficiency, or the diffraction efficiency to the ½-th power may be used. In this case, there are multiple definition expressions of the SNR, and, for example, it can be expressed by the following expressions. In this case, μ_{ON} is an average value of ON pixels, μ_{OFF} is an average value of OFF pixels, σ_{ON} is a standard deviation of ON pixels, and σ_{OFF} is a standard deviation of OFF pixels. In order to express in decibel, 20 log of the values of the following expressions may be calculated.

SNR=(μ_{ON}+μ_{OFF})/(σ_{ON}+σ_{OFF}) (Expression 8)

SNR=(μ_{ON}+μ_{OFF})/(σ_{ON}²+σ_{OFF}²)^{0.5} (Expression 9)

FIG. 18 is a schematic diagram illustrating an embodiment of a recording condition adjustment circuit in the optical information recording/reproduction device. The buffer memory 401 in the recording condition adjustment circuit 92 inputs the reproduction signal from the pickup 11, and outputs the reproduction signal to the Signal detection circuit 402 and the Scatter detection circuit 403. The Signal detection circuit 402 calculates the Signal value of each page data from the information about the reproduction signal received from the buffer memory 401, and outputs the Signal value to the SSR calculation circuit 404. The Scatter detection circuit 403 calculates the Scatter value of each page data from the information about the reproduction signal received from the buffer memory 401, and outputs the Scatter value to the SSR calculation circuit 404. The SSR calculation circuit 404 inputs the Signal value from the Signal detection circuit 402 and the Scatter value from the Scater detection circuit 403, calculates the SSR, and outputs the SSR to the exposure light energy density calculation circuit 406. The exposure light energy density calculation circuit 406 inputs the SSR value, calculates the exposure light energy density in order to record page data of the target SSR, and outputs the exposure light energy density to the controller 89. Information about the recording exposure light energy density required during calculation may be saved to the exposure light energy density calculation circuit 406 itself, or may be input from the controller 89.

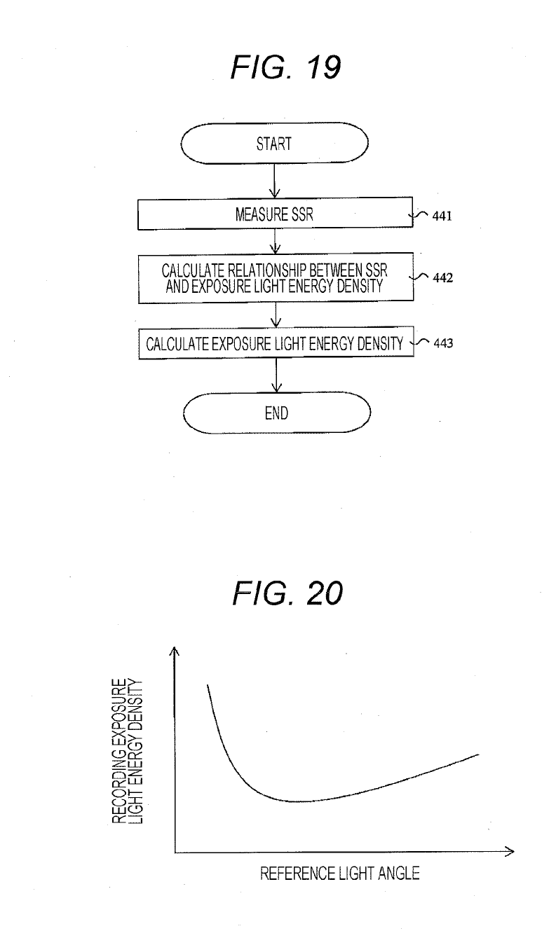

FIG. 19 is a schematic diagram illustrating an embodiment of an operation flow of recording condition adjustment in the recording condition adjustment circuit 92 of the optical information recording/reproduction device. During adjustment of the recording condition, first, the SSR is measured in 441. Subsequently, in 442, the relationship of the SSR and the exposure light energy density is calculated. Subsequently, in 443, the exposure light energy density with which the page data of the target SSR are recorded is calculated. During the user data recording, the recording is performed using the exposure light energy density calculated and optimized. The exposure light energy density calculated and optimized may be stored in an optical information recording/reproduction device, a device for controlling the optical information recording/reproduction device, an optical information recording medium, or cartridge storing the optical information recording medium.

In the method according to the present embodiment, even if there are less recording pages during the adjustment, the exposure light energy density can be calculated by using the linear interpolation or the approximated curve, and therefore, there is an advantage the recording condition can be adjusted in a shorter time or less processing.

In the explanation below, explanation about the same contents as the present embodiment is omitted.

### Fourth Embodiment

A fourth embodiment according to the present invention will be explained with reference to FIGS. 25 and 26.

FIG. 25 is a schematic diagram illustrating an example of relationship of recording exposure light energy density and reference light angle in the optical information recording/reproduction device. During adjustment of the recording condition according to the present embodiment, multiple books are recorded, while the scheduling waveform is changed, in the adjustment area on the optical information recording medium. Thereafter, the page in each book is reproduced, and the scheduling waveform for higher quality reproduction is derived.

In this case, when the scheduling waveform is changed, for example, the basic scheduling waveform is multiplied by an adjustment coefficient a. Thereafter, the recording/reproduction is performed using the scheduling waveform multiplied by the adjustment coefficient, and the reproduction quality is measured. At this occasion, recording is performed with multiple conditions while the adjustment coefficient a is changed, and an adjustment coefficient a′ for higher quality reproduction is derived, and the adjusted scheduling waveform is generated as a basic scheduling waveform multiplied by a′. In this case, the basic scheduling waveform is saved in, for example, an optical information recording medium, a cartridge storing the optical information recording medium, an optical information recording/reproduction device, or a device for controlling an optical information recording/reproduction device, and the basic scheduling waveform is read and used before the adjustment.

FIG. 26 is a schematic diagram illustrating an example of relationship of the SSR average value and the correction coefficient a in the optical information recording/reproduction device. When the optimum value a′ of the adjustment coefficient is derived, for example, first, multiple books are recorded while changing the adjustment coefficient, and in each book, the SSR average value of all the pages is calculated, and a relationship between the SSR average value and the adjustment coefficient a is derived. Subsequently, the adjustment coefficient a for attaining the target SSR is calculated using, for example, interpolation method and the like, and is adopted as the optimum value a′. In this case, the SSR is used as the index, for example. But it is not limited to the SSR, and for example, the SNR, the reproduction light intensity, the reproduction light intensity to the ½-th power, the diffraction efficiency, or the diffraction efficiency to the ½-th power may be used.

In the method according to the present embodiment, the exposure light energy density is adjusted by recording/reproducing multiple books while changing the numerical value by which the basic scheduling waveform is multiplied, and therefore, as compared with the method according to the third embodiment for performing adjustment in a simplified manner by changing the exposure light energy density for each page, there is an advantage in that the adjustment can be done with a higher precision recording condition.

The present invention is not limited to above embodiments, and various modifications are included. For example, the above embodiments are provided to explain the present invention in details in an easy to understand manner, and the present invention is not limited to those having all the constituent elements explained. Some of the constituent elements of a certain embodiment may be replaced with constituent elements of another embodiment, and the constituent elements of a certain embodiment may be added to constituent elements of another embodiment. Some of the constituent elements of each embodiment may be added, deleted, or replaced with constituent elements of another embodiment.

Some or all of the above configurations, functions, processing units, processing means, and the like may be realized with hardware by designing an integrated circuit, for example. The above configuration, functions, and the like may be realized with software by causing a processor to interpret and execute a program achieving the functions. Information such as the programs, tables, files for achieving the functions can be placed in a recording device such as a memory, a hard disk, an SSD (Solid State Drive) and a recording medium such as an IC card, an SD card, and a DVD.

The control lines and information lines which are considered to be necessary for explanation are shown. Not all the control lines and information lines in a product may be shown. In reality, substantially all the constituent elements may be considered to be connected with each other.

### REFERENCE SIGNS LIST

1 optical information recording medium
2 adjustment area
10 optical information recording/reproduction device
11 pickup
12 reproduction reference light optical system
13 disk Cure optical system
14 disk rotation angle detection optical system
81 access control circuit
82 light source driving circuit
83 servo signal generation circuit
84 servo control circuit
85 signal processing circuit
86 signal generation circuit
87 shutter control circuit
88 disk rotation motor control circuit
89 controller
90 input/output control circuit
91 external control device
92 recording condition adjustment circuit
301 light source
303 shutter
306 signal light
307 reference light
308 beam expander
309 phase mask
310 relay lens
311 PBS prism
312 spatial light modulation device
313 relay lens
314 spatial filter
315 object lens
316 polarization direction conversion device
320 actuator
321 lens
322 lens
323 actuator
324 mirror
325 light detection device
401 buffer memory
402 Signal detection circuit
403 Scatter detection circuit
404 SSR calculation circuit
405 target Signal calculation circuit
406 exposure light energy density calculation circuit
422 M/# detection circuit
423 sensitivity detection circuit
424 exposure light energy density calculation circuit
501 light source
502 collimate lens
503 shutter
504 optical device
505 PBS prism
506 signal light
507 PBS prism
508 spatial light modulation device
509 angle filter
510 object lens
511 object lens actuator
512 reference light
513 mirror
514 mirror
515 lens
516 galvano mirror
517 actuator
518 light detection device
519 polarization direction conversion device
520 driving direction
521 optical block

1. An optical information recording/reproduction device configured to record or reproduce information to an optical information recording medium by using holography,
the optical information recording/reproduction device comprising:
a light source configured to emit a signal light and a reference light;
a spatial light modulation device configured to modulate the signal light;
an angle adjustment unit configured to adjust an angle of the reference light; and
a recording condition adjustment unit configured to adjust a recording condition in an area of the optical information recording medium,
wherein the modulated signal light and the adjusted reference light are emitted to the optical information recording medium, so that a two-dimensional signal is recorded to the area,
the recording condition adjustment unit adjusts a recording condition on the basis of a signal-to-scatter ratio (SSR) of the two-dimensional signal in the area, and
in a case where a signal group of reproduction light intensity reproduced, while an angle of the reference light is changed, from the area is divided into each of predetermined angles of the reference light, a value of the signal of the SSR is substantially a maximum value in a range of the signal group thus divided, and a value of scatter of the SSR is substantially a minimum value in the range of the signal group thus divided.

2. The optical information recording/reproduction device according to claim 1, wherein the recording condition adjustment unit adjusts the recording condition so that variation in the signal-to-scatter ratio of the two-dimensional signal with multiple reference light angles is within a predetermined range.

3. The optical information recording/reproduction device according to claim 1, wherein the recording condition adjustment unit adjusts the recording condition so that the signal-to-scatter ratio of the two-dimensional signal with multiple reference light angles becomes constant.

4. The optical information recording/reproduction device according to claim 1, wherein the recording condition adjustment unit adjusts the recording condition so that the signal-to-scatter ratio of the two-dimensional signal with multiple reference light angles is equal to or more than a predetermined value.

5. The optical information recording/reproduction device according to claim 1, wherein the recording condition adjustment unit measures a sensitivity and/or M/# of the optical information recording medium, and adjusts the recoding condition from information about the sensitivity and/or the M/#.

6. The optical information recording/reproduction device according to claim 1, wherein the recording condition adjustment unit adjusts the recording condition by multiplying a previously defined basic scheduling waveform by a coefficient so that a signal-to-scatter ratio of the two-dimensional signal becomes a predetermined value, and the recording condition is determined on the basis of a scheduling waveform multiplied by the coefficient and adjusted.

7. The optical information recording/reproduction device according to claim 1, wherein the recording condition adjustment unit saves information about the adjusted recording condition to an optical information recording medium, a cartridge storing the optical information recording medium, an optical information recording/reproduction device, or a device controlling an optical information recording/reproduction device.

8. The optical information recording/reproduction device according to claim 1, wherein the recording condition adjustment unit refers to the information about the recording condition saved in an optical information recording medium, a cartridge storing an optical information recording medium, an optical information recording/reproduction device, or a device controlling an optical information recording/reproduction device, and adjusts the recording condition on the basis of the information referred to.

9. An optical information recording medium configured to record or reproduce information, while an angle of the reference light is changed, by using holography, wherein a recording condition with which the optical information recording medium is recorded is stored in the optical information recording medium before shipment,
the recording condition includes a signal-to-scatter ratio (SSR) suitable for recording the optical information recording medium, and
in a case where a signal group of reproduction light intensity reproduced, while an angle of the reference light is changed, from the area on the optical information recording medium is divided into each of predetermined angles of the reference light, a value of the signal of the SSR is substantially a maximum value in a range of the signal group thus divided, and a value of scatter of the SSR is substantially a minimum value in the range of the signal group thus divided.

10. The optical information recording medium according to claim 9, wherein the recording condition further includes information about M/# and/or sensitivity of the optical information recording medium.

11. A recording condition adjustment method in an optical information recording medium recorded with information by using holography,
the recording condition adjustment method comprising:
a step of emitting the signal light and the reference light;
a step of modulating the signal light;
a step of adjusting an angle of the reference light;
a recording condition adjustment step of adjusting a recording condition in an area of the optical information recording medium; and
a step of emitting the modulated signal light and the adjusted reference light to the optical information recording medium, thus recording a two-dimensional signal to the area,
wherein in the recording condition adjustment step, the recording condition is adjusted on the basis of a signal-to-scatter ratio (SSR) of the two-dimensional signal in the area, and
in a case where a signal group of reproduction light intensity reproduced, while an angle of the reference light is changed, from the area is divided into each of predetermined angles of the reference light, a value of the signal of the SSR is substantially a maximum value in a range of the signal group thus divided, and a value of scatter of the SSR is substantially a minimum value in the range of the signal group thus divided.

12. The recording condition adjustment method according to claim 11, wherein in the recording condition adjustment step, the recording condition is adjusted so that variation in the signal-to-scatter ratio of the two-dimensional signal with multiple reference light angles is within a predetermined range.

13. The recording condition adjustment method according to claim 11, wherein the recording condition is adjusted so that the signal-to-scatter ratio of the two-dimensional signal with multiple reference light angles becomes constant.

14. The recording condition adjustment method according to claim 11, wherein in the recording condition adjustment step, the recording condition is adjusted so that the signal-to-scatter ratio of the two-dimensional signal with multiple reference light angles is equal to or more than a predetermined value.

15. The recording condition adjustment method according to claim 11, wherein in the recording condition adjustment step, a sensitivity and/or M/# of the optical information recording medium are measured, and the recoding condition is adjusted from information about the sensitivity and/or the M/#.

16. The recording condition adjustment method according to claim 11, wherein in the recording condition adjustment step, the recording condition is adjusted by multiplying a previously defined basic scheduling waveform by a coefficient so that a signal-to-scatter ratio of the two-dimensional signal becomes a predetermined value, and the recording condition is determined on the basis of a scheduling waveform multiplied by the coefficient and adjusted.

17. The recording condition adjustment method according to claim 11, wherein in the recording condition adjustment step, information about the adjusted recording condition is saved to an optical information recording medium, a cartridge storing the optical information recording medium, an optical information recording/reproduction device, or a device controlling an optical information recording/reproduction device.

18. The recording condition adjustment method according to claim 11, wherein in the recording condition adjustment step, the information about the recording condition saved in an optical information recording medium, a cartridge storing an optical information recording medium, an optical information recording/reproduction device, or a device controlling an optical information recording/reproduction device is referred to, and the recording condition is adjusted on the basis of the information referred to.

19. The optical information recording/reproduction device according to claim 1, wherein the adjustment of the recording condition is an adjustment of an exposure light energy density.

20. The recording condition adjustment method according to claim 11, wherein the adjustment of the recording condition is an adjustment of an exposure light energy density.

21. The optical information recording/reproduction device according to claim 1, wherein the recording condition adjustment unit records/reproduces desired adjustment data by using all areas of the reference light angle used when user data are recorded in an area provided for adjustment of the recording condition in the optical information recording medium before the user data are recorded,
a scatter quantity is calculated in all areas of the reference light angle from reproduction information of the adjustment data,
a signal quantity is calculated in order to make the signal-to-scatter ratio substantially constant in all the areas of the reference light angle from the scatter quantity, and
the recording condition for obtaining the signal quantity is calculated from relationship of an accumulative intensity and an accumulative exposure light energy density obtained from reproduction information of the adjustment data.

22. The optical information recording/reproduction device according to claim 21,
wherein the recording condition adjustment unit records/reproduces the adjustment data by using the adjusted recording condition,
the recording condition adjustment unit determines whether the signal-to-scatter ratio is substantially constant in the reproduction information of the adjustment data,
in a case where the signal-to-scatter ratio is substantially constant, the user data are recorded by using the recording condition, and
in a case where the signal-to-scatter ratio is not substantially constant, the adjustment of the recording condition is repeated until the signal-to-scatter ratio becomes substantially constant.

23. The recording condition adjustment method according to claim 11, wherein in the recording condition adjustment step,
desired data are recorded/reproduced by using all areas of the reference light angle used when user data are recorded in an area provided for adjustment of the recording condition in the optical information recording medium before the user data are recorded,
a scatter quantity is calculated in all areas of the reference light angle from reproduction information of the adjustment data,
a signal quantity is calculated in order to make the signal-to-scatter ratio substantially constant in all the areas of the reference light angle from the scatter quantity, and
the recording condition for obtaining the signal quantity is calculated from relationship of an accumulative intensity and an accumulative exposure light energy density.

24. The optical information recording/reproduction method according to claim 23, wherein in the recording condition adjustment step,
the adjustment data are recorded/reproduced by using the adjusted recording condition
a determination is made as to whether the signal-to-scatter ratio is substantially constant in the reproduction information of the adjustment data,
in a case where the signal-to-scatter ratio is substantially constant, the user data are recorded by using the recording condition, and
in a case where the signal-to-scatter ratio is not substantially constant, the adjustment of the recording condition is repeated until the signal-to-scatter ratio becomes substantially constant.
